(19) United States
(12) Patent Application Publication
(10) Pub. No.: US 2006/0132970 A1
(43) Pub. Date: Jun. 22, 2006

(54) Magnetic recording/reproducing device, magnetic recording medium, and magnetic head

(75) Inventors: Mitsuru Takai, Tokyo (JP); Katsumichi Tagami, Tokyo (JP); Kazuya Shimakawa, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/297,362

(22) Filed: Dec. 9, 2005

(30) Foreign Application Priority Data
Dec. 16, 2004 (JP) 2004-365002

(51) Int. Cl. G11B 5/127

(52) U.S. Cl. 360/125

(57) ABSTRACT

A perpendicular magnetic recording/reproducing device that can suppress broadening of recording magnetic fields and that is capable of effective application of magnetic field to a recording target track is provided. The device includes a magnetic recording medium having a soft magnetic layer and a recording layer having a perpendicular magnetic anisotropy formed in this order over a substrate, and a magnetic head. The soft magnetic layer is formed with a concavo-convex pattern in which at least part of regions corresponding to tracks of the recording layer protrudes toward the recording layer, and convex portions are provided with the magnetic anisotropy in the circumferential direction of the tracks. The magnetic head includes a main pole for generating a recording magnetic field, and a return pole to which the magnetic field returns, the main pole and the return pole being arranged side by side in a track width direction.

### BACKGROUND OF THE INVENTION

1. Field of the Invention

The present invention relates to a perpendicular magnetic recording/reproducing device, and a magnetic recording medium and a magnetic head installed in the device.

2. Description of the Related Art

There has been a remarkable increase in areal density of magnetic recording media such as hard disks by various improvements including reduction in the grain size of magnetic particles forming the recording layer, material changes, and finer head processing. Also, perpendicular magnetic recording media, which have an enhanced areal density because of the recording layer having a magnetic anisotropy in the direction which is perpendicular to the surface thereof and a soft magnetic layer provided under the recording layer are being put in use.

In the perpendicular magnetic recording media, the soft magnetic layer helps to attract a recording magnetic field from the magnetic pole as well as to constitute a return path through which the magnetic field applied to the recording layer from a main pole in the magnetic head returns to a return pole. The main pole and return pole are arranged side by side in the circumferential direction of the track of the magnetic recording medium, and most of the magnetic flux from the main pole passes through the soft magnetic layer in the circumferential direction and returns to the return pole.

To achieve good recording/reproducing characteristics, it is preferable that the soft magnetic layer should intensify the recording magnetic field linearly, and that magnetization of the soft magnetic layer should vanish when the recording magnetic field is removed. However, magnetization caused by the recording magnetic field may remain aligned in a specific direction in the soft magnetic layer. Since the flux of recording magnetic field passes through the soft magnetic layer mainly in the circumferential direction of the track as mentioned above, if the soft magnetic layer has such a magnetic anisotropy, the magnetization remains along the circumferential direction even after the recording magnetic field is removed, which will cause noise when reproducing data. Moreover, the soft magnetic layer may have magnetic domains of opposite magnetization separated by a domain wall. In this case, a spike noise occurs during reproduction, which is a major cause of error.

Therefore, an antiferromagnetic layer is usually provided on the substrate side of the soft magnetic layer so that the direction of the magnetic anisotropy is fixed substantially perpendicular to main magnetic field components which is parallel to surface of the magnetic recording medium, as well as along the track width direction that is substantially parallel to surface of the medium, in order to suppress a remanent magnetization caused by the recording magnetic field of the magnetic head.

The areal density of magnetic recording media has thus been increased and a further improvement is expected. On the other hand, it has become evident that existing techniques for increasing the areal density have reached their limits because of processing limits of magnetic heads, the problem of erroneous writing of data on adjacent tracks of a recording target track caused by fringing magnetic fields from the magnetic head, and the problem of crosstalk at the time of reproduction.

Accordingly, a magnetic recording medium such as a discrete track medium and a patterned medium, in which a recording layer is formed by a predetermined concavo-convex pattern, are being developed as a candidate of a magnetic recording medium that enables a further increase in the areal density (see, for example, Japanese Patent Laid-Open Publication No. Hei 7-129953). Such discrete track media and patterned media should also preferably have a perpendicular recording design for increasing the areal density.

However, while the perpendicular recording enables enhancement of areal density to a certain extent, another problem arises: The soft magnetic layer formed continuously under the recording layer attracts the recording magnetic field not only to the recording target track but also to adjacent tracks. That is, the field fringing effect becomes larger, and it reduces the effect of enhancing the areal density achieved by the perpendicular recording design.

### SUMMARY OF THE INVENTION

In view of the foregoing problems, various exemplary embodiments of this invention provide a perpendicular magnetic recording/reproducing device that can suppress broadening of recording magnetic fields and that is capable of effective application of magnetic field to a recording target track, and a magnetic recording medium and a magnetic head installed in the device.

To achieve the above object, various exemplary embodiments of this invention provide a perpendicular magnetic recording/reproducing device wherein a soft magnetic layer has a concavo-convex pattern in which at least part of the regions corresponding to tracks of a recording layer protrudes toward the recording layer further than adjacent areas, and the soft magnetic layer has a magnetic anisotropy in the circumferential direction of the tracks; and wherein a main pole and a return pole of the magnetic head are arranged side by side in a width direction of the tracks.

The inventors first produced a magnetic recording medium alone, as described above before devising the present invention. Namely, the soft magnetic layer was formed with a concavo-convex pattern in which parts corresponding to the tracks of the recording layer protruded towards the recording layer. It was expected that the recording magnetic field could be concentrated onto a target track, with less field broadening. According to the conventional practice, an antiferromagnetic layer was formed on the substrate side of the soft magnetic layer so that the soft magnetic layer has a fixed magnetic anisotropy in the track width direction.

However, the recording characteristics changed each time data was written, a large spike noise that causes a reproduction error was observed, and moreover the random noise level increased. These problems were attributable to a change in the magnetic anisotropy of the soft magnetic layer, caused by its concavo-convex pattern. More specifically, the soft magnetic layer formed in an elongated shape tends to have a magnetic anisotropy in the lengthwise direction. Therefore, in the convex portions of the soft magnetic layer formed correspondingly to the tracks of the recording layer, the magnetic anisotropy is aligned in the lengthwise direction, i.e., the circumferential direction of the track. That is, even though the magnetic anisotropy of the soft magnetic layer was controlled by the antiferromagnetic layer on the substrate side so as to align the magnetization direction along the track width, the convex portions of the soft magnetic layer acquired a magnetic anisotropy in the circumferential direction, because of which a large remanent magnetization was observed even after the recording magnetic field was removed. This is considered to have caused changes in the recording characteristics that occurred each time data was written. Also, magnetic domains were created depending on the pattern of magnetization in the recording layer, leading to spike noise and an increase in the random noise component.

Through intensive research, the inventors have completed the present invention, wherein the convex portions of the soft magnetic layer is provided with a magnetic anisotropy in the circumferential direction of the track, and a main pole and a return pole of the magnetic head are arranged side by side in the track width direction.

Thereby, broadening of the recording magnetic field is suppressed, and also, it is ensured that the direction of the recording magnetic field is different from the direction of the magnetic anisotropy of the soft magnetic layer, so that no large remanent magnetization is observed or no magnetic domains are created in the soft magnetic layer by the recording magnetic field after the recording magnetic field is removed, to prevent spike noise or the like. Moreover, the width of the surfaces of the main pole of the magnetic head facing the return pole can be made larger without being limited by the track width of the magnetic recording medium, which brings formation of a favorable magnetic flux of the recording magnetic field.

Accordingly, various exemplary embodiments of the invention provide

a magnetic recording/reproducing device comprising a magnetic recording medium including a soft magnetic layer and a recording layer having a magnetic anisotropy in a direction perpendicular to a surface thereof, formed in this order over a substrate, and a magnetic head for recording data onto the magnetic recording medium, wherein

the soft magnetic layer is formed with a concavo-convex pattern in which at least part of regions corresponding to tracks of the recording layer protrudes toward the recording layer further than adjacent areas, and convex portions of the soft magnetic layer are provided with a magnetic anisotropy in a circumferential direction of the tracks; and

the magnetic head includes a main pole for generating a recording magnetic field, and a return pole to which the magnetic field returns, the main pole and the return pole being arranged side by side along a width direction of the tracks.

Moreover, various exemplary embodiments of the invention provide

magnetic recording medium comprising a soft magnetic layer and a recording layer having a magnetic anisotropy in a direction perpendicular to a surface thereof, formed in this order over a substrate, the soft magnetic layer being formed with a concavo-convex pattern in which at least part of regions corresponding to tracks of the recording layer protrudes toward the recording layer further than adjacent areas, and convex portions of the soft magnetic layer having a magnetic anisotropy in a circumferential direction of the tracks.

Furthermore, various exemplary embodiments of the invention provide

a magnetic head comprising a main pole for generating a recording magnetic field, and a return pole to which the magnetic field returns, being mountable such as that the main pole and the return pole being movable along a predetermined path, and the main pole and the return pole being arranged side by side in a direction along the path.

The “soft magnetic layer formed with a concavo-convex pattern” in this description refers not only to a continuous soft magnetic layer formed with convex portions and concave portions, but also to a soft magnetic layer having convex portions that are partially continuous in regions other than the concave portions, and a soft magnetic layer having convex portions that are completely divided from each other.

The term “magnetic recording medium” used in this description should not be limited to hard disks, “floppy” (registered trademark) disks, magnetic tapes and the like which use only magnetism for writing and reading data, but should include other recording media such as magneto optical (MO) recording media that use light with magnetism and heat assisted recording media that use heat with magnetism.

The present invention as described above provides a perpendicular magnetic recording/reproducing device with reduced broadened fields and less noise from the soft magnetic layer.

### BRIEF DESCRIPTION OF THE DRAWINGS

FIG. 1 is a schematic perspective view showing the structure of main parts of a magnetic recording/reproducing device according to a first exemplary embodiment of the invention;

FIG. 2 is an enlarged cross-sectional side view schematically showing the structure of a magnetic recording medium in the magnetic recording/reproducing device taken along the track width direction;

FIG. 3 is a schematic perspective view showing the structure of main parts of the magnetic recording medium and a magnetic head in the magnetic recording/reproducing device;

FIG. 4 is a schematic cross-sectional side view showing the magnetic anisotropy of a soft magnetic layer and an antiferromagnetic layer of the magnetic recording medium taken along the circumferential direction of the track;

FIG. 5 is a plan view schematically showing the structure near the distal end of the magnetic head of the magnetic recording/reproducing device viewed from the medium side;

FIG. 6 is a schematic plan view of an annealing process in the manufacture of the magnetic recording medium;

FIG. 7 is a side view of FIG. 6;

FIG. 8 is a schematic perspective view showing the structure of main parts of a magnetic recording medium and a magnetic head in a magnetic recording/reproducing device according to a second exemplary embodiment of the invention;

FIG. 9 is a schematic perspective view showing the structure of main parts of a magnetic recording medium and a magnetic head in a magnetic recording/reproducing device according to a third exemplary embodiment of the invention; and

FIG. 10 is a schematic perspective view showing the structure of main parts of a magnetic recording medium and a magnetic head in a magnetic recording/reproducing device according to a fourth exemplary embodiment of the invention.

### DETAILED DESCRIPTION OF THE INVENTION

Preferred exemplary embodiments of the present invention will be hereinafter described in detail with reference to the accompanying drawings.

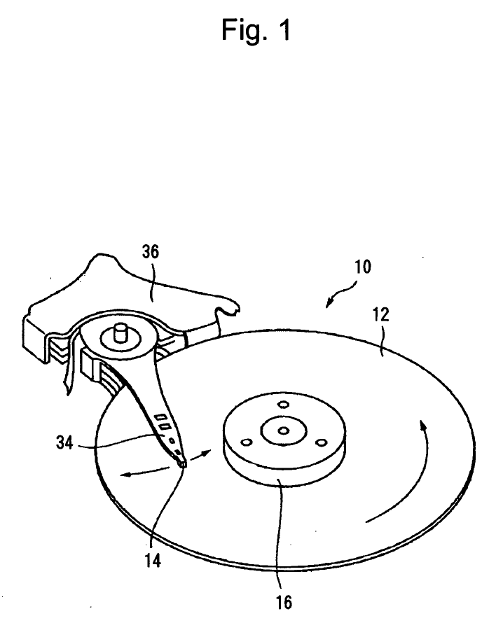

A magnetic recording/reproducing device 10 according to a first exemplary embodiment of the present invention includes, as shown in FIG. 1, a magnetic recording medium 12 and a magnetic head 14 for writing and reading data to and from the magnetic recording medium 12.

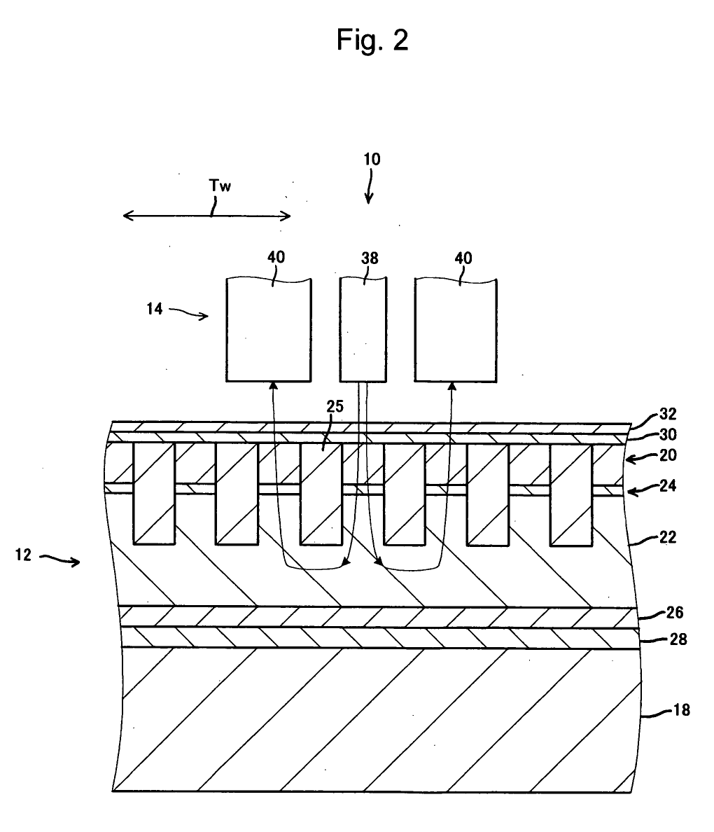

The magnetic recording medium 12 is a perpendicular recording, discrete track type magnetic disk and secured to a chuck 16 so that it is rotatable with the chuck 16. As shown in FIG. 2, the magnetic recording medium 12 includes a substrate 18, and a soft magnetic layer 22 and a recording layer 20 formed in this order over the substrate 18. The recording layer 20 is formed in a concavo-convex pattern of concentric tracks finely spaced in the radial direction in a data region. The soft magnetic layer 22 is formed also in a concavo-convex pattern that matches the track pattern of the recording layer 20. Although not shown, the recording layer 20 and the soft magnetic layer 22 are formed with predetermined servo information patterns in a servo region.

The substrate 18 has a mirror-finished surface on the side of the soft magnetic layer 22. The substrate 18 is made of a non-magnetic material such as glass, an NiP-coated Al alloy, Si, Al₂O₃, or the like.

The recording layer 20 has a thickness of 5 to 30 nm and is made of a Co/Cr alloy such as Co/Cr/Pt, a Fe/Pt alloy, a stack of these alloys, or a material in which an oxide material such as SiO₂ contains particles of ferromagnetic material such as Co/Pt in a matrix fashion or the like.

A seed layer 24 is formed between the recording layer 20 and the soft magnetic layer 22 so as to provide the recording layer 20 with the magnetic anisotropy in the thickness direction (perpendicular to the surface). The seed layer 24 is formed in a concavo-convex pattern of tracks similarly to the recording layer 20. The seed layer 24 has a thickness of 2 to 40 nm and is made of a non-magnetic Co/Cr alloy, Ti, Ru, a stack of Ru and Ta, MgO, or the like.

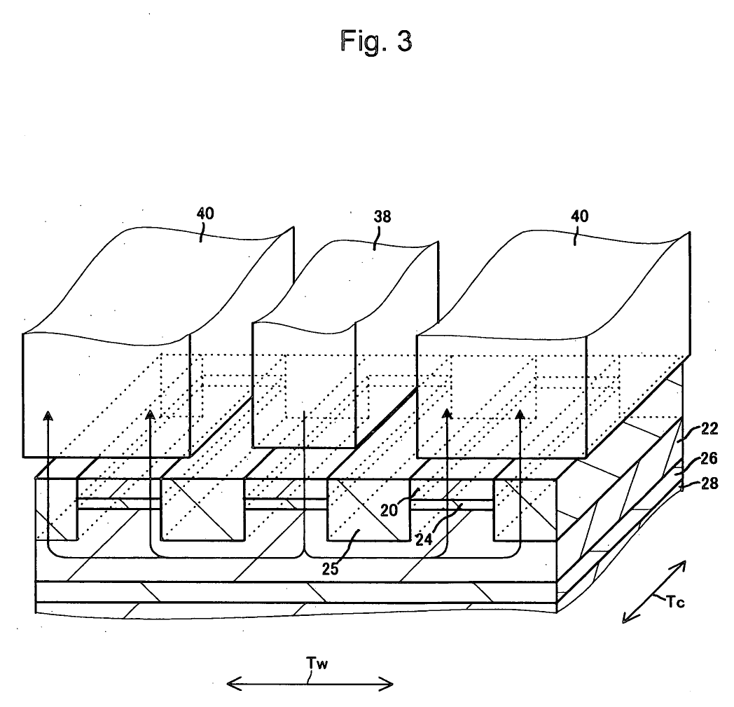

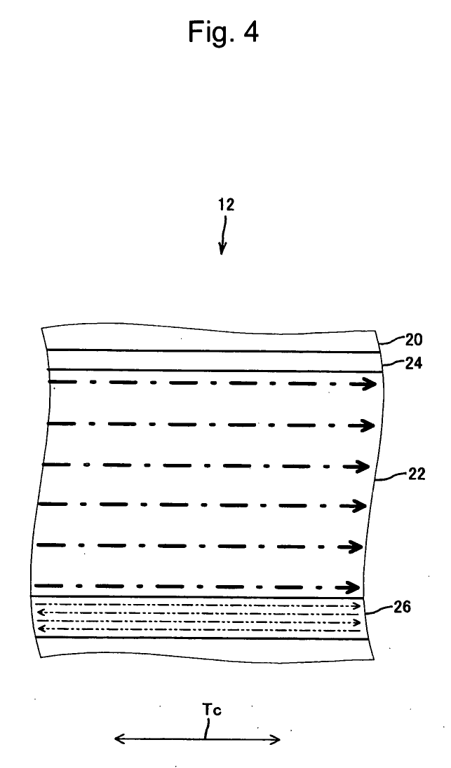

The soft magnetic layer 22 has a concavo-convex pattern as shown in FIG. 3 such that the parts corresponding to the tracks of the recording layer 20 protrude toward the recording layer 20 further than the adjacent areas. Further, convex portions of the soft magnetic layer 22 is provided with a magnetic anisotropy in the circumferential direction of the tracks as indicated by the dot-dash arrows in FIG. 4. Thus the convex portions of the soft magnetic layer 22 are formed in an elongated shape along the circumferential direction of the track to match the track shape of the recording layer 20 in the data region. The arrows denoted at Tw indicate the width direction and the arrows denoted at Tc indicate the circumferential direction of the track in FIG. 2 to FIG. 4.

The thickness of the soft magnetic layer 22 from the lower face to the upper face of the convex portions is 50 to 300 nm. The soft magnetic layer 22 is made of a Fe (iron) alloy, a Co(cobalt)-amorphous alloy, ferrite or the like. Alternatively, the soft magnetic layer 22 may be a stack of a soft magnetic layer and a non-magnetic layer.

The concave portions of the concavo-convex pattern of the recording layer 20, the seed layer 24, and the soft magnetic layer 22 are filled with a non-magnetic material 25 up to the top surface of the recording layer 20. The non-magnetic material 25 is, for example, an oxide material such as SiO₂, Al₂O₃, TiO₂, ferrite, a nitride such as AlN, or a carbide such as SiC or the like.

An antiferromagnetic layer 26 is formed under the soft magnetic layer 22 on the side of the substrate 18 in the thickness direction, so as to fix the direction of the magnetic anisotropy of the soft magnetic layer 22 along the circumferential direction.

The antiferromagnetic layer 26 has a thickness of 5 to 50 nm and is made of, for example, a Fe/Mn alloy, a Pt/Mn alloy, an Ir/Mn alloy, oxide film of NiO or the like. The antiferromagnetic layer 26 has a magnetic anisotropy in the circumferential direction of the track as indicated by two-dot-dash arrows in FIG. 4. More specifically, the two-dot-dash arrows express the antiparallel arrangement of magnetic moment of the antiferromagnetic layer 26 along the circumferential direction of the track. The antiferromagnetic layer 26 makes contact with the soft magnetic layer 22 on its substrate 18 side so as to fix the direction of the magnetic anisotropy of the soft magnetic layer 22 along the circumferential direction by the exchange coupling between them.

An underlayer 28 is formed between the antiferromagnetic layer 26 and the substrate 18. The underlayer 28 has a thickness of 2 to 40 nm and is made of Ta or the like.

A protective layer 30 and a lubricating layer 32 are formed over the recording layer 20 in this order. The protective layer 30 has a thickness of 1 to 5 nm and made of, for example, a film of hard carbon that is also referred to as diamond like carbon. It should be noted that the term “diamond like carbon” (hereinafter “DLC”) in this description refers to a material that is mainly composed of carbon and has an amorphous structure and a hardness of about 2×10⁹ to 8×10¹⁰ Pa measured by Vickers hardness testing. The lubricating layer 32 has a thickness of 1 to 2 nm and is made of PFPE (perfluoropolyether), or the like. Note, the protective layer 30 and the lubricating layer 32 are not shown in FIG. 3 for easy understanding of the arrangement of the magnetic head 14 and the magnetic recording medium 12.

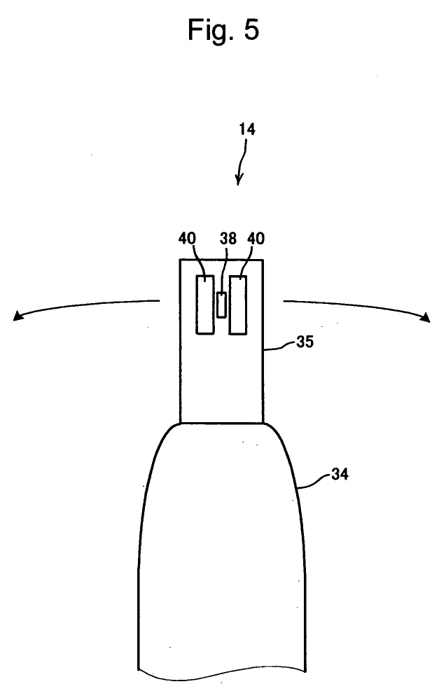

The magnetic head 14 includes an arm 34, a slider 35, a main pole 38 for generating a recording magnetic field, and return poles 40 to which the flux of recording magnetic field returns. The arm 34 is rotatably mounted to a base 36 near its base end. The slider 35 is mounted at the tip of the arm 34 and movable in close proximity to the surface of the magnetic recording medium 12 in an arc path along the radial direction of the magnetic recording medium 12 (track width direction) as indicated by the arrows in FIG. 5.

As shown in FIG. 2, FIG. 3, and FIG. 5, the main pole 38 and the return poles 40 are arranged side by side on the slider 35 along the track width direction (in the same direction as the arc path). The two return poles 40 are symmetrically arranged on both sides of the main pole 38. The flux of magnetic field generated by the main pole 38 passes mainly through the soft magnetic layer 22 of the magnetic recording medium 12 in the track width direction and returns to the return poles 40. The thickness in the track width direction of the return poles 40 is actually several tens larger than that of the main pole 38. The width of the return poles 40 (in the circumferential direction of the track) is actually several tens larger than that of the main pole 38. The magnetic head 14 also includes a reproducing head, which is not shown for ease of illustration in FIG. 2, FIG. 3, and FIG. 5.

Next, the operation of this magnetic recording/reproducing device 10 will be described.

Because the soft magnetic layer 22 of the magnetic recording medium 12 is formed in a concavo-convex pattern wherein the parts corresponding to the tracks of the recording layer 20 protrude further than the other parts in the data region, broadening of the recording magnetic field is suppressed. The flux of magnetic field from the main pole 38 is attracted toward the recording target tracks upon the convex portions of the soft magnetic layer 22 as indicated by the arrows in FIG. 2 and FIG. 3. This suppresses the broadening of the recording magnetic field.

Because the convex portions of the soft magnetic layer 22 are formed in the shape that matches the tracks of the recording layer 20 in the data region, the shape being elongated in the circumferential direction of the track, the convex portions are provided with a magnetic anisotropy in the circumferential direction. Further, the antiferromagnetic layer 26 is formed on the substrate 18 side of the soft magnetic layer 22 for fixing the direction of the magnetic anisotropy of the soft magnetic layer 22 along the circumferential direction. Thus the direction of the magnetic anisotropy of the soft magnetic layer 22 is stably fixed in the circumferential direction.

Meanwhile, because the main pole 38 and the return poles 40 of the magnetic head 14 are arranged side by side along the track width direction, the main components of the magnetic flux inside the magnetic recording medium 12 that are parallel to the surface of the magnetic recording medium 12 are substantially parallel to the track width direction.

As the direction of the recording magnetic field lines in the magnetic head 14 is different from the direction of the magnetic anisotropy of the soft magnetic layer 22, large remanent magnetization or magnetic domains caused by the remanent magnetization is suppressed after the recording magnetic field is removed, whereby spike noise is effectively prevented.

Also because the two return poles 40 are symmetrically arranged on both sides of the main pole 38 in the magnetic head 14, the magnetic flux of the recording magnetic field is created in a favorable manner. With improved symmetry of the recording magnetic field, the recording layer 20 can be magnetized more evenly in the track width direction.

Furthermore, because the main pole 38 and the return poles 40 of the magnetic head 14 are arranged side by side along the track width direction, the width of the surfaces of the main pole 38 facing the return poles 40 can be made larger without being limited by the track width. This further ensures formation of a favorable magnetic flux of the recording magnetic field.

It was the common practice to arrange the main pole and the return pole of the magnetic head along the circumferential direction of the track and to fix the direction of the magnetic anisotropy of the soft magnetic layer along the track width direction. In contrast, in this magnetic recording/reproducing device 10, the soft magnetic layer 22 is formed with a concavo-convex pattern in which the convex portions are formed in the shape that matches the tracks of the recording layer 20, so that the recording magnetic field in the magnetic head 14 is concentrated on the tracks, and that the direction of the magnetic anisotropy of the soft magnetic layer 22 is fixed in the circumferential direction of the track. Further, the main pole 38 and the return poles 40 of the magnetic head 14 are arranged side by side along the track width direction so as to suppress noise caused by remanent magnetization or magnetic domains in the soft magnetic layer 22 after the recording magnetic field is removed. Thus the device of the invention is structured based on a completely new concept.

Moreover, because the recording layer 20 is formed in a shape of tracks in the data region, the magnetic recording medium 12 can achieve a high areal density without causing the problems of writing data on adjacent tracks of a recording target track or cross-talk at the time of reproduction.

Also, since the recording layer 20 of this magnetic recording medium 12 is divided into parts in the form of tracks in the data region, no noise is generated from the concave portions between the tracks, whereby good recording/reproducing characteristics are achieved.

Furthermore, as the concave portions are filled with the non-magnetic material 25 up to the top surface of the recording layer 20, the magnetic recording medium 12 has a flat surface and the head flying height is made stable, whereby good recording/reproducing characteristics are achieved also in this respect.

Next, the method of manufacturing the magnetic recording medium 12 will be briefly described.

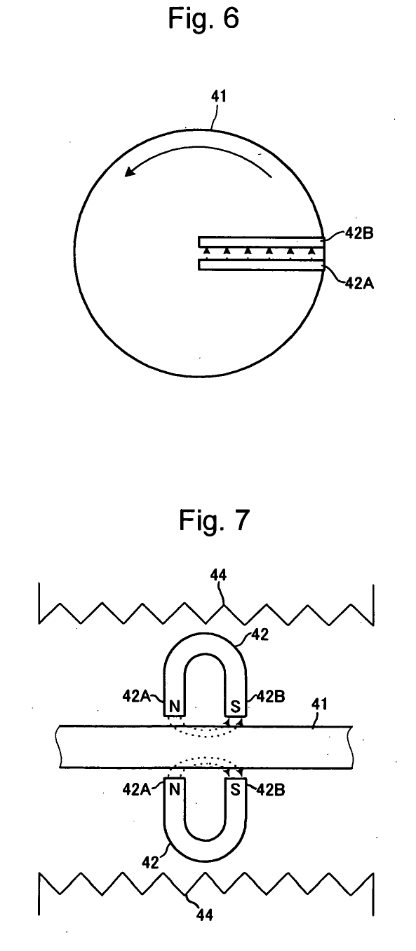

First, an underlayer 28, an antiferromagnetic layer 26, a soft magnetic layer 22, a seed layer 24, and a recording layer 20 are formed in this order over the substrate 18 by a sputtering process or the like, after which a resist layer is formed by spin coat application, to obtain an object to be processed 41 (see FIG. 6 and FIG. 7).

Next, a concavo-convex pattern corresponding to the track pattern of the data region is transferred to the resist layer by a nanoimprint method, after which the resist layer, the recording layer 20, the seed layer 24, and the soft magnetic layer 22 under the bottom of the concave portions are removed by a dry etching process, to thereby forming the concave portions up to halfway point of the soft magnetic layer 22 in the thickness direction. Thus the recording layer 20 and the seed layer 24 are divided into elements by the concavo-convex pattern, and the soft magnetic layer 22 is formed with the concavo-convex pattern. The convex portions of the soft magnetic layer 22 are formed in an elongated shape along the circumferential direction corresponding to the tracks of the recording layer 20 in the data region, so that the soft magnetic layer 22 is provided with a magnetic anisotropy in the circumferential direction. One or a plurality of mask layers may be formed between the recording layer 20 and the resist layer, and these layers may be divided by a plurality of dry etching processes.

Next, a non-magnetic material 25 is deposited on the object to be processed 41 by a sputtering process or the like to fill the concave portions of the recording layer 20, the seed layer 24, and the soft magnetic layer 22. After that, excess non-magnetic material 25 above the recording layer 20 is removed by an ion beam etching method wherein a process gas is irradiated at an angle to the rotating object 41, so as to flatten the surface.

Next, a protective layer 30 is deposited by a CVD method or the like, and a lubricating layer 32 is applied by a dipping method.

The object to be processed 41 thus obtained is placed in an annealing furnace, where U-shaped magnets 42 having about the same width as the radius of the object to be processed 41 are arranged on both sides in the thickness direction of the object to be processed 41, as shown in FIG. 6 and FIG. 7. More specifically, the magnetic poles 42A and 42B of the magnets 42 are arranged in close proximity to the object to be processed 41 along its radius. The magnets 42 may be, but not limited to, rare earth magnets such as Nd—Fe—B magnets or Sm—Co magnets. Using heaters 44, the object to be processed 41 is heated to a temperature higher than the blocking temperature of the antiferromagnetic layer 26. Then, an external magnetic field is applied by the magnets 42 along the circumferential direction of the object to be processed 41 while it is rotated. By gradually cooling down the object to be processed 41 in this state maintained, the soft magnetic layer 22 and the antiferromagnetic layer 26 each acquire a magnetic anisotropy in the circumferential direction of the tracks. Further, the direction of the magnetic anisotropy of the soft magnetic layer 22 is fixed in the circumferential direction by exchange coupling between the antiferromagnetic layer 26 and the soft magnetic layer 22. The magnetic recording medium 12 is thus obtained.

Next, a second exemplary embodiment of the invention will be described.

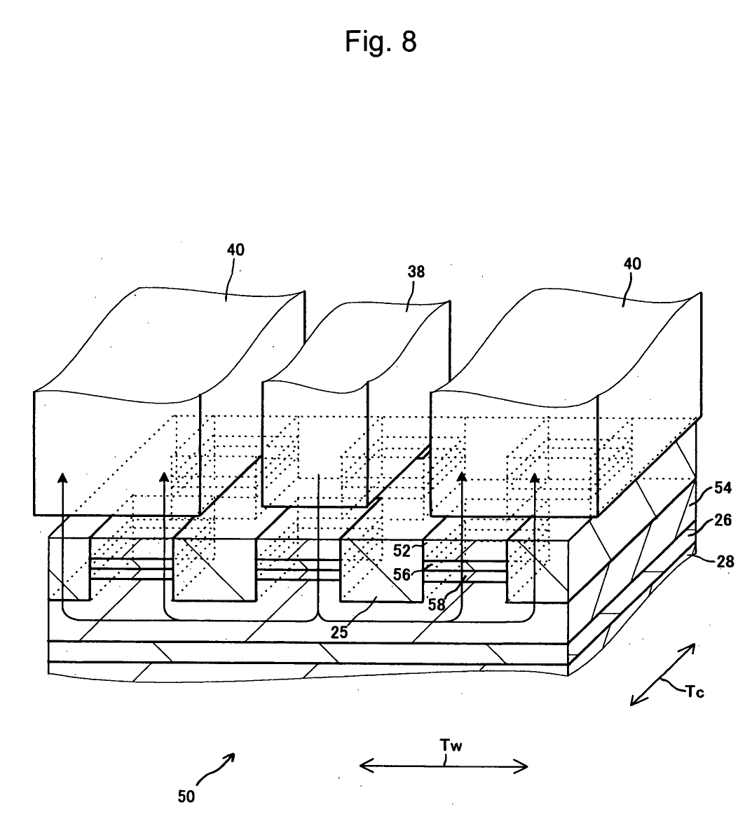

The magnetic recording medium 50 according to the second exemplary embodiment is a perpendicular recording, patterned medium. Unlike the magnetic recording medium 12 of the first exemplary embodiment, the recording layer 52 is discontinuous in the circumferential direction of concentric tracks, as shown in FIG. 8. More specifically, the recording layer 52 is divided at fine intervals both in the radial and circumferential directions in the data region. The soft magnetic layer 54 has a concavo-convex pattern wherein the parts corresponding to the convex portions of the recording layer 52 (part of regions corresponding to the tracks of the recording layer) protrude toward the recording layer 52 further than the adjacent areas. An antiferromagnetic layer 58 is formed between the seed layer 56 and the soft magnetic layer 54 so as to be in contact with the upper surface of the soft magnetic layer 54. The seed layer 56 is also divided at fine intervals both in the radial and circumferential directions similarly to the recording layer 52. Other features are the same as the previously described magnetic recording medium 12 and will not be described again. Note, as with FIG. 3, the protective layer 30 and the lubricating layer 32 are not shown in FIG. 8 for easy understanding of the arrangement of the magnetic head 14 and the magnetic recording medium 50.

Similarly to the magnetic recording medium 12, the magnetic recording medium 50 can achieve a high areal density without causing the problems of writing data on adjacent tracks of a recording target track or cross-talk at the time of reproduction. Also, no noise is generated from the concave portions between the tracks, whereby good recording/reproducing characteristics are achieved.

Further, broadening of the recording magnetic field is suppressed, and large remanent magnetization or magnetic domains will be suppressed in the soft magnetic layer 54 after the recording magnetic field is removed, whereby spike noise is effectively suppressed.

Further, because the antiferromagnetic layer 26 is provided on the substrate 18 side of the soft magnetic layer 54, and because another antiferromagnetic layer 58 is provided on the recording layer 52 side of the soft magnetic layer 54, the direction of the magnetic anisotropy of the convex portions of the soft magnetic layer 54 is fixed stably in the circumferential direction of the track even though the convex portions are short in the circumferential direction.

Next, a third exemplary embodiment of the invention will be described.

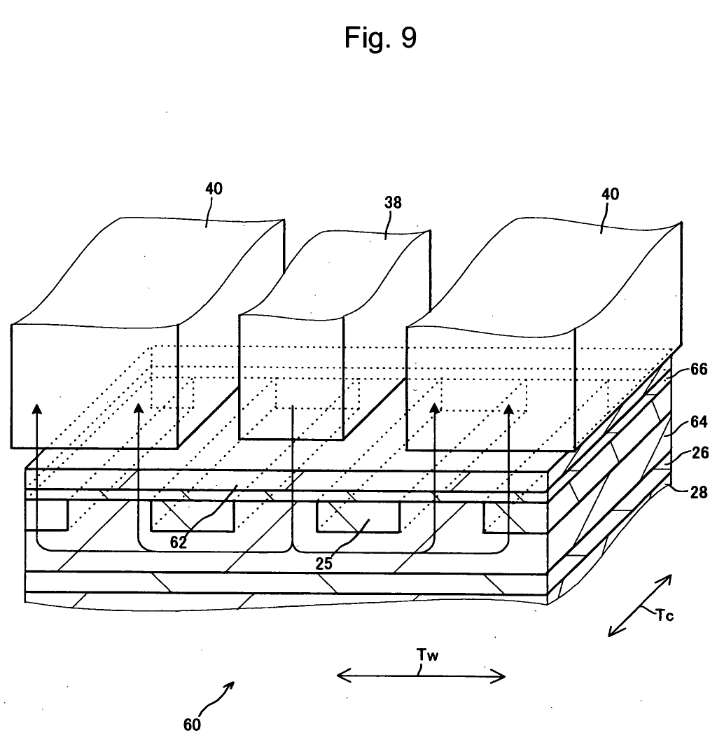

The magnetic recording medium 60 according to the third exemplary embodiment is a perpendicular recording magnetic disk. Unlike the first exemplary embodiment of the magnetic recording medium 12, the recording layer 62 is a continuous film as shown in FIG. 9, and the soft magnetic layer 64 has a concavo-convex pattern wherein the parts corresponding to the tracks of the recording layer 62 protrude toward the recording layer 62 further than the adjacent areas. The seed layer 66 is also a continuous film similarly to the recording layer 62. Other features are the same as the previously described magnetic recording medium 12 and will not be described again. Note, as with FIG. 3, the protective layer 30 and the lubricating layer 32 are not shown in FIG. 9 for easy understanding of the arrangement of the magnetic head 14 and the magnetic recording medium 60.

The concave portions of the concavo-convex pattern of the soft magnetic layer 64 are filled with a non-magnetic material 25 up to the top surface of the soft magnetic layer 64.

Similarly to the magnetic recording medium 12, the recording magnetic field from the main pole 38 is directed toward the recording target tracks upon the convex portions of the soft magnetic layer 64, whereby broadening of the recording magnetic field is suppressed. As the direction of the recording magnetic field lines in the magnetic head 14 is different from the direction of the magnetic anisotropy of the soft magnetic layer 64, large remanent magnetization or magnetic domains is suppressed in the soft magnetic layer 64 after the recording magnetic field is removed, whereby spike noise is effectively suppressed.

The manufacturing method of the magnetic recording medium 60 is briefly described below. As compared to the manufacturing method of the magnetic recording medium 12, the soft magnetic layer 64 is processed to have the concavo-convex pattern before depositing the seed layer 66 and the recording layer 62. Other processes are the same as those of the previously described method, and therefore will not be described again.

First, an underlayer 28, an antiferromagnetic layer 26, and a soft magnetic layer 64 are formed in this order over the substrate 18 by a sputtering process, after which a resist layer is formed by spin coat application, to obtain an object to be processed.

Next, a concavo-convex pattern corresponding to the track pattern of the data region is transferred to the resist layer by a nanoimprint method, after which the resist layer and the soft magnetic layer 64 under the bottom of the concave portions are removed by a dry etching process, to thereby form the concave portions up to halfway point of the soft magnetic layer 64 in the thickness direction. Thus the soft magnetic layer 64 is formed in a concavo-convex pattern. The convex portions of the soft magnetic layer 64 are formed in an elongated shape along the circumferential direction corresponding to the tracks of the recording layer 62 in the data region, so that convex portions of the soft magnetic layer 64 are provided with a magnetic anisotropy in the circumferential direction. One or a plurality of mask layers may be formed between the soft magnetic layer 64 and the resist layer, and the soft magnetic layer 64 may be processed into the concavo-convex pattern by a plurality of dry etching processes.

Next, a non-magnetic material 25 is deposited on the object to be processed by a sputtering process or the like to fill the concave portions of the soft magnetic layer 64. After that, excess non-magnetic material 25 above the soft magnetic layer 64 is removed by an ion beam etching method wherein a process gas is irradiated at an angle to the object to be processed with the object to be processed being rotated, so as to flatten the surface.

A seed layer 66 and a recording layer 62 are then deposited by a sputtering process or the like. Further, as with the previously described method, a protective layer 30 is deposited by a CVD method or the like, and a lubricating layer 32 is deposited by a dipping method. The object is then placed in an annealing furnace, and an external magnetic field is applied so as to provide the soft magnetic layer 64 and the antiferromagnetic layer 26 with a magnetic anisotropy in the circumferential direction. The magnetic recording medium 60 is thus obtained.

Next, a fourth exemplary embodiment of the invention will be described.

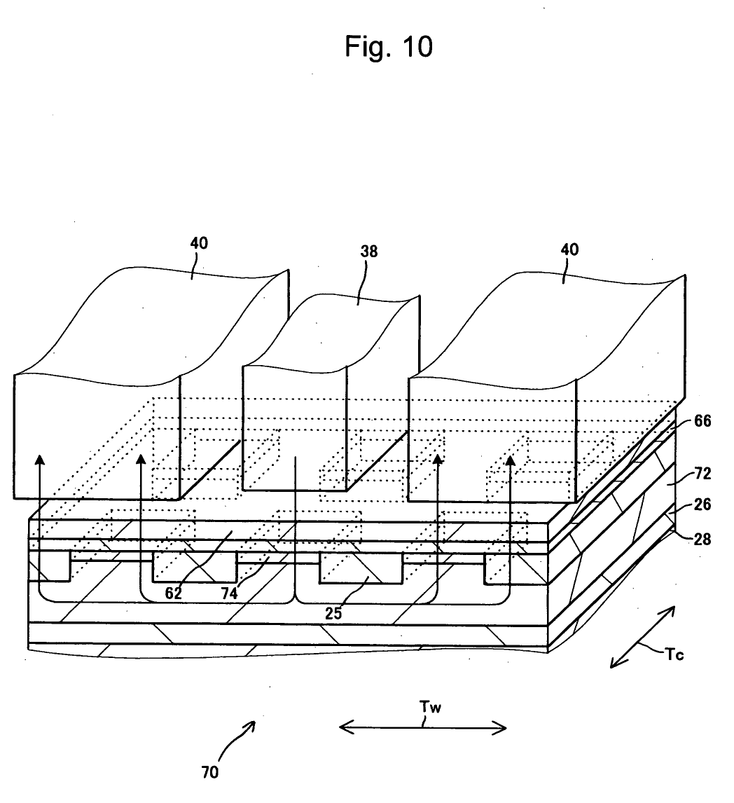

The magnetic recording medium 70 according to the fourth exemplary embodiment of the invention is characterized in that, as compared to the magnetic recording medium 60 according to the third exemplary embodiment, the soft magnetic layer 72 has a concavo-convex pattern wherein part of regions corresponding to the tracks of the recording layer 62 protrudes toward the recording layer 62 further than the adjacent areas as shown in FIG. 10. An antiferromagnetic layer 74 is formed between the seed layer 66 and the soft magnetic layer 72 so as to be in contact with the upper surface of the soft magnetic layer 72. Other features are the same as the previously described magnetic recording medium 60 and will not be described again. Note, as with FIG. 3, the protective layer 30 and the lubricating layer 32 are not shown in FIG. 10 for easy understanding of the arrangement of the magnetic head 14 and the magnetic recording medium 70.

Similarly to the magnetic recording medium 60, broadening of the recording magnetic field of the magnetic head 14 in the magnetic recording medium 60 is suppressed. As the direction of the recording magnetic field lines of the magnetic head 14 in the magnetic recording medium 60 is different from the direction of the magnetic anisotropy of the soft magnetic layer 72, large remanent magnetization or magnetic domains is suppressed in the soft magnetic layer 72 after the recording magnetic field is removed, whereby noise is effectively suppressed.

Further, because the antiferromagnetic layer 26 is provided on the substrate 18 side of the soft magnetic layer 72, and because another antiferromagnetic layer 74 is provided on the recording layer 62 side of the soft magnetic layer 72, the direction of the magnetic anisotropy of the convex portions of the soft magnetic layer 72 is fixed stably in the circumferential direction of the track even though the convex portions are short in the circumferential direction.

In the first to fourth exemplary embodiments described above, the antiferromagnetic layer 26 is formed in contact with the substrate 18 side of the soft magnetic layer 22, 54, 64, or 72 so as to fix the direction of the magnetic anisotropy of the soft magnetic layer 22, 54, 64, or 72 in the circumferential direction of the track. If the convex portions of the soft magnetic layer 22, 54, 64, or 72 are sufficiently long in the circumferential direction and the concave portions are sufficiently deep to ensure that the direction of the magnetic anisotropy thereof is fixed in the circumferential direction, the antiferromagnetic layer is not absolutely necessary.

On the other hand, if the convex portions of the soft magnetic layer have substantially the same length in the circumferential direction as the width direction, or if the convex portions are longer in the width direction, the direction of the magnetic anisotropy of the convex portions may not be fixed in the circumferential direction. Also, even if the convex portions are longer in the circumferential direction, the direction of the magnetic anisotropy may not be fixed stably depending on the shape of the convex portions. In such cases, the antiferromagnetic layer may be formed in contact with convex portions of the soft magnetic layer on the side of the recording layer, to enhance the effect of fixing the direction of the magnetic anisotropy in the track circumferential direction. Further, as with the second or the fourth exemplary embodiment described above, the antiferromagnetic layer may be formed in contact with both sides of the soft magnetic layer, to further enhance the effect of fixing the direction of the magnetic anisotropy of the convex portions of the soft magnetic layer in the circumferential direction.

While the soft magnetic layer 22, 54, 64, or 72 has concave portions etched up to halfway point thereof in the thickness direction in the first to fourth exemplary embodiments described above, the concave portions may be etched through to the lower surface so that the soft magnetic layer is completely divided.

In the first and second exemplary embodiments, the concavo-convex pattern of the soft magnetic layer 22 or 54 is formed such that parts corresponding to the convex portions of the recording layer 20 or 52 protrude toward the recording layer 22 or 54 further than the adjacent areas. This is not an absolute requirement and only part of the regions of the soft magnetic layer corresponding to the convex portions of the recording layer may protrude toward the recording layer. In this case, too, the recording magnetic field from the main pole is attracted toward the recording target tracks upon the convex portions of the soft magnetic layer, and the effect of suppressing field broadening is achieved in some degree.

While the underlayer 28 and the antiferromagnetic layer 26 are formed between the soft magnetic layer 22, 54, 64, or 72 and the substrate 18 in the first to fourth exemplary embodiments described above, the layer structure between the substrate 18 and the soft magnetic layer 22, 54, 64, or 72 may be changed in accordance with the type of the magnetic recording medium and various needs. The underlayer 28, for example, may be omitted.

The layer structure between the soft magnetic layer 22, 54, 64, or 72 and the recording layer 20, 52, or 62 is also not limited to the examples given above. For example, the seed layer 24, 56, or 66 may be omitted, and the recording layer 20, 52, or 62 may be formed directly on the soft magnetic layer 22, 54, 64, or 72. When an antiferromagnetic layer is to be provided, this should be formed in contact with the soft magnetic layer.

While the concave portions of the soft magnetic layer 22 or 54 are filled with the non-magnetic material 25 in the first and second exemplary embodiments described above, the concave portions may be left unfilled if the head flying height is sufficiently stable.

While the magnetic head 14 has two return poles 40 arranged symmetrically on both sides of the main pole 38 in the first to fourth exemplary embodiments described above, other designs are possible. For example, one return pole and one main pole may be arranged side by side in the track width direction.

While the recording layer 20, 52, or 62 and other layers are formed on one side of the substrate 18 in the first to fourth exemplary embodiments described above, the invention is applicable to double-sided magnetic recording media which have a recording layers and other layers on both sides of the substrate.

Also, the invention is applicable to magneto optical (MO) discs, heat assisted magnetic disks which use heat together with magnetism, and other non-disc-like magnetic recording media such as magnetic tapes that have a recording layer formed in a concavo-convex pattern.

What is claimed is:

1. A magnetic recording/reproducing device comprising a magnetic recording medium including a soft magnetic layer and a recording layer having a magnetic anisotropy in a direction perpendicular to a surface thereof, formed in this order over a substrate, and a magnetic head for recording data onto the magnetic recording medium, wherein
the soft magnetic layer is formed with a concavo-convex pattern in which at least part of regions corresponding to tracks of the recording layer protrudes toward the recording layer further than adjacent areas, and convex portions of the soft magnetic layer are provided with a magnetic anisotropy in a circumferential direction of the tracks; and
the magnetic head includes a main pole for generating a recording magnetic field, and a return pole to which the magnetic field returns, the main pole and the return pole being arranged side by side along a width direction of the tracks.

2. The magnetic recording/reproducing device according to claim 1, wherein
the convex portions of the soft magnetic layer each have an elongated shape along the circumferential direction of the tracks.

3. The magnetic recording/reproducing device according to claim 1, wherein
an antiferromagnetic layer is formed in contact with at least one side in a thickness direction of the soft magnetic layer to fix the direction of the magnetic anisotropy of the soft magnetic layer in the circumferential direction of the tracks.

4. The magnetic recording/reproducing device according to claim 2, wherein
an antiferromagnetic layer is formed in contact with at least one side in a thickness direction of the soft magnetic layer to fix the direction of the magnetic anisotropy of the soft magnetic layer in the circumferential direction of the tracks.

5. The magnetic recording/reproducing device according to claim 1, wherein
the recording layer is formed with a concavo-convex pattern in which at least part of regions corresponding to the tracks protrudes toward an opposite side from the substrate further than adjacent areas, and the soft magnetic layer is formed with a concavo-convex pattern in which at least part of regions corresponding to convex portions of the concavo-convex pattern of the recording layer protrudes toward the recording layer further than adjacent areas.

6. The magnetic recording/reproducing device according to claim 2, wherein
the recording layer is formed with a concavo-convex pattern in which at least part of regions corresponding to the tracks protrudes toward an opposite side from the substrate further than adjacent areas, and the soft magnetic layer is formed with a concavo-convex pattern in which at least part of regions corresponding to convex portions of the concavo-convex pattern of the recording layer protrudes toward the recording layer further than adjacent areas.

7. The magnetic recording/reproducing device according to claim 3, wherein
the recording layer is formed with a concavo-convex pattern in which at least part of regions corresponding to the tracks protrudes toward an opposite side from the substrate further than adjacent areas, and the soft magnetic layer is formed with a concavo-convex pattern in which at least part of regions corresponding to convex portions of the concavo-convex pattern of the recording layer protrudes toward the recording layer further than adjacent areas.

8. The magnetic recording/reproducing device according to claim 4, wherein
the recording layer is formed with a concavo-convex pattern in which at least part of regions corresponding to the tracks protrudes toward an opposite side from the substrate further than adjacent areas, and the soft magnetic layer is formed with a concavo-convex pattern in which at least part of regions corresponding to convex portions of the concavo-convex pattern of the recording layer protrudes toward the recording layer further than adjacent areas.

9. A magnetic recording medium comprising a soft magnetic layer and a recording layer having a magnetic anisotropy in a direction perpendicular to a surface thereof, formed in this order over a substrate, the soft magnetic layer being formed with a concavo-convex pattern in which at least part of regions corresponding to tracks of the recording layer protrudes toward the recording layer further than adjacent areas, and convex portions of the soft magnetic layer having a magnetic anisotropy in a circumferential direction of the tracks.

10. The magnetic recording medium according to claim 9, wherein
an antiferromagnetic layer is formed in contact with at least one side in a thickness direction of the soft magnetic layer to fix the direction of the magnetic anisotropy of the soft magnetic layer in the circumferential direction of the tracks.

11. The magnetic recording medium according to claim 9, wherein
convex portions of the soft magnetic layer each have an elongated shape along the circumferential direction of the tracks.

12. The magnetic recording medium according to claim 10, wherein
convex portions of the soft magnetic layer each have an elongated shape along the circumferential direction of the tracks.

13. The magnetic recording medium according to claim 9, wherein
the recording layer is formed with a concavo-convex pattern in which at least part of regions corresponding to the tracks protrudes toward an opposite side from the substrate further than adjacent areas, and the soft magnetic layer is formed with a concavo-convex pattern in which at least part of regions corresponding to convex portions of the concavo-convex pattern of the recording layer protrudes toward the recording layer further than adjacent areas.

14. The magnetic recording medium according to claim 10, wherein
the recording layer is formed with a concavo-convex pattern in which at least part of regions corresponding to the tracks protrudes toward an opposite side from the substrate further than adjacent areas, and the soft magnetic layer is formed with a concavo-convex pattern in which at least part of regions corresponding to convex portions of the concavo-convex pattern of the recording layer protrudes toward the recording layer further than adjacent areas.

15. The magnetic recording medium according to claim 11, wherein
the recording layer is formed with a concavo-convex pattern in which at least part of regions corresponding to the tracks protrudes toward an opposite side from the substrate further than adjacent areas, and the soft magnetic layer is formed with a concavo-convex pattern in which at least part of regions corresponding to convex portions of the concavo-convex pattern of the recording layer protrudes toward the recording layer further than adjacent areas.

16. The magnetic recording medium according to claim 12, wherein
the recording layer is formed with a concavo-convex pattern in which at least part of regions corresponding to the tracks protrudes toward an opposite side from the substrate further than adjacent areas, and the soft magnetic layer is formed with a concavo-convex pattern in which at least part of regions corresponding to convex portions of the concavo-convex pattern of the recording layer protrudes toward the recording layer further than adjacent areas.

17. A magnetic head comprising a main pole for generating a recording magnetic field, and a return pole to which the magnetic field returns, being mountable such as that the main pole and the return pole being movable along a predetermined path, and the main pole and the return pole being arranged side by side in a direction along the path.

18. The magnetic head according to claim 17, wherein the return pole is arranged on both sides of the main pole.
